(19) United States
(12) Patent Application Publication
(10) Pub. No.: US 2010/0108095 A1
(43) Pub. Date: May 6, 2010

(54) SUBSTRATE PROCESSING APPARATUS AND SUBSTRATE CLEANING METHOD

(75) Inventors: Nobuhiko MOURI, Kumamoto (JP); Seiki ISHIDA, Kumamoto (JP); Kenji SEKIGUCHI, Yamanashi (JP); Takehiko ORII, Saga (JP)

Correspondence Address: CANTOR COLBURN, LLP, 20 Church Street, 22nd Floor, Hartford, CT, 06103, US

(73) Assignee: TOKYO ELECTRON LIMITED, Tokyo (JP)

(21) Appl. No.: 12/611,143

(22) Filed: Nov. 3, 2009

(30) Foreign Application Priority Data
Nov. 4, 2008 (JP) 2008-282967

(51) Int. Cl. B08B 3/00

(52) U.S. Cl. 134/6; 134/99.1; 134/18

(57) ABSTRACT

Disclosed are a substrate processing apparatus and a substrate cleaning method to satisfactorily clean the entire circumferential periphery of a substrate, including an upper surface circumferential periphery, an end, and a lower surface circumferential periphery of the substrate. The substrate processing apparatus includes a substrate supporter to support the substrate, a first cleaner to clean the upper surface circumferential periphery of the substrate with a pressurized cleaning liquid, and a second cleaner to clean the end and the lower surface circumferential periphery of the substrate while contacting the end and the lower surface circumferential periphery of the substrate with a cleaning member. The first cleaner cleans the upper surface circumferential periphery of the substrate, and the second cleaner cleans the end and the lower surface circumferential periphery of the substrate.

This application is based on and claims priority from Japanese Patent Application No. 2008-282967, filed on Nov. 4, 2008, with the Japanese Patent Office, the disclosure of which is incorporated herein in its entirety by reference.

### TECHNICAL FIELD

The present disclosure relates to a substrate processing apparatus to clean a circumferential periphery of an upper surface, an end, and a circumferential periphery of a lower surface of a substrate, and a substrate cleaning method used for the substrate processing apparatus.

### BACKGROUND

Generally, in a process of manufacturing a semiconductor component or a flat display device, a substrate cleaning process for cleaning a substrate, such as a semiconductor wafer or a liquid crystal substrate, is conducted.

In a substrate, when an upper surface (a main surface) having a circuit pattern formed thereon is polluted with pollutants, such as particles, the pattern formation by exposure may be hindered. Also, when the circumferential periphery of the upper surface (the upper surface circumferential periphery) is polluted, the pollutants may float in the liquid where the substrate is dipped and then may be re-attached to the upper surface of the substrate, during the dipping processing or liquid immersion lithography. Moreover, when the end or the circumferential periphery of the lower surface (the lower surface circumferential periphery) is polluted, the pollutants may be transferred to other substrates through a supporter during carrying or processing the substrate.

Accordingly, the circumferential periphery of a substrate, where a circuit pattern is not formed, is cleaned in a substrate cleaning process, and the circumferential periphery of the upper surface, where a circuit pattern is formed, of the substrate and the end and the lower surface circumferential periphery of the substrate are cleaned in the process of cleaning the circumferential periphery of the substrate.

In a substrate processing apparatus used for such a process for cleaning the circumferential periphery of the substrate, a substrate supporter rotates the substrate while supporting it. Herein, the circumferential periphery of the substrate is disposed between a couple of upper/lower cleaning brushes, and the cleaning brushes clean the circumferential periphery of the substrate by rubbing it while being in contact with the upper surface circumferential periphery, the end, and the lower surface circumferential periphery of the substrate. For example, see Japanese Laid-Open Patent Publication No. 2007-157936.

In the substrate processing apparatus, the circumferential periphery of the substrate is disposed between cleaning brushes to clean the upper surface circumferential periphery, the end, and the lower surface circumferential periphery of the substrate. Thus, the cleaning area of the upper surface circumferential periphery of the substrate and the cleaning area of the lower surface circumferential periphery of the substrate cannot be separately controlled. Also, when the cleaning area of the upper surface of the substrate is set in consideration of the circuit pattern, the cleaning area of the lower surface circumferential periphery of the substrate may be insufficient. Also, since the upper surface circumferential periphery of the substrate is cleaned by the cleaning brushes, the difference in the size or expansion rate of individual cleaning brushes may cause damage to the circuit pattern formed on the upper surface of the substrate or insufficient cleaning.

### SUMMARY

According to one embodiment, there is provided a substrate processing apparatus. The substrate processing apparatus includes a substrate supporter to support a substrate, a first cleaner to clean an upper surface circumferential periphery of the substrate with a pressurized cleaning liquid, and a second cleaner to clean an end and a lower surface circumferential periphery of the substrate while contacting the end and the lower surface circumferential periphery of the substrate with a cleaning member.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a plan view illustrating a substrate processing apparatus according to one embodiment.

FIG. 2 is a plan view illustrating a substrate processing unit.

FIG. 3 is a side view of FIG. 2.

FIG. 4 is an explanatory view illustrating the state of a circumferential periphery of a substrate during cleaning.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

According to one embodiment, there is provided a substrate processing apparatus. The substrate processing apparatus includes a substrate supporter to support a substrate, a first cleaner to clean an upper surface circumferential periphery of the substrate with a pressurized cleaning liquid, and a second cleaner to clean an end and a lower surface circumferential periphery of the substrate while contacting the end and the lower surface circumferential periphery of the substrate with a cleaning member.

A two-fluid nozzle may be used as the first cleaner, and a cleaning brush may be used as the second cleaner.

The first cleaner and the second cleaner may be used to simultaneously clean the upper surface circumferential periphery, the end and the lower surface circumferential periphery of the substrate.

A substrate rotating mechanism to rotate the substrate may be provided in the substrate supporter, and an upper-side cleaning liquid supplier may be provided to supply a cleaning liquid to an upper center portion of the substrate.

The substrate rotating mechanism may rotate the substrate at a rotation rate that causes the cleaning liquid supplied from the upper-side cleaning liquid supplier to flow around the end of the substrate and reach the lower surface circumferential periphery of the substrate.

A cleaning liquid blower may be provided to blow out the cleaning liquid supplied from the upper-side cleaning liquid supplier from the upper surface circumferential periphery of the substrate toward outside of the substrate.

The first cleaner may be provided with a moving mechanism, and the first cleaner may move from a position above the center portion of the substrate to a position above the upper surface circumferential periphery to clean the upper surface of the substrate.

A bottom-side cleaning liquid supplier may be provided to supply a cleaning liquid to the lower surface circumferential periphery of the substrate.

According to another embodiment, a substrate processing method is provided. The substrate processing method includes cleaning an upper surface circumferential periphery of a substrate with a pressurized cleaning liquid, and cleaning an end and a lower surface circumferential periphery of the substrate while contacting the end and the lower surface circumferential periphery of the substrate with a cleaning member.

The upper surface circumferential periphery of the substrate, and the end and the lower surface circumferential periphery of the substrate may be cleaned simultaneously.

The method may further include rotating the substrate and supplying the cleaning liquid to an upper center portion of the substrate.

The substrate may be rotated at such a rotation rate that the cleaning liquid flows around the end of the substrate and reaches the lower surface circumferential periphery of the substrate.

The method may further include blowing out the cleaning liquid from the upper surface circumferential periphery of the substrate toward outside of the substrate.

The method may further include cleaning from the upper center portion to the upper surface circumferential periphery of the substrate.

The method may further include rinsing the substrate by supplying a cleaning liquid to the upper surface circumferential periphery, the end, and the lower surface circumferential periphery of the substrate after the upper surface circumferential periphery, the end, and the lower surface circumferential periphery of the substrate are cleaned.

According to one embodiment, the upper surface circumferential periphery of the substrate is cleaned by a pressurized cleaning liquid, and the end and the lower surface circumferential periphery of the substrate are cleaned while being in contact with a cleaning member. Thus, the cleaning area of the upper surface circumferential periphery of the substrate and the cleaning area of the lower surface circumferential periphery may be separately controlled, thereby optimizing the cleaning of the circumferential periphery of the substrate. Also, the occurrence of damage to the circuit pattern or the insufficient cleaning at the upper surface circumferential periphery of the substrate can be inhibited, so that the circumferential periphery of the substrate can be satisfactorily cleaned.

Hereinafter, a specific configuration of a substrate processing apparatus according to the embodiments will be described with reference to drawings.

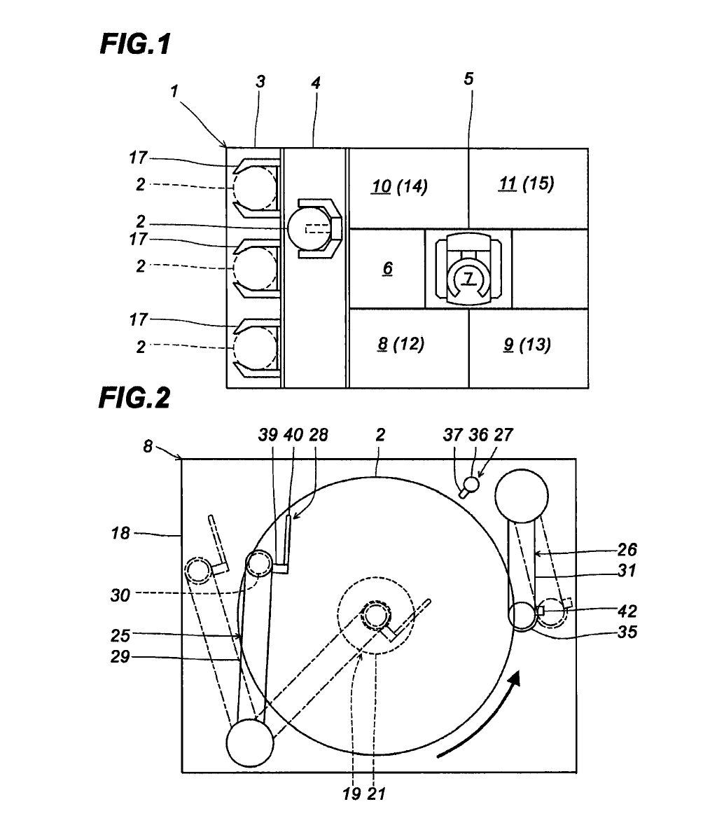

As shown in FIG. 1, a substrate processing apparatus 1 includes a substrate loading/unloading part 3 to load and unload a semiconductor wafer (hereinafter, referred to as “a substrate 2”) at a front end, a substrate carrying part 4 to carry substrate 2 at the rear of substrate loading/unloading part 3, and a substrate processing part 5 to perform various kinds of processes, such as cleaning or drying, on substrate 2 at the rear of substrate carrying part 4.

Substrate processing part 5 includes a substrate transfer unit 6 to transfer substrate 2 at the rear of substrate carrying part 4 and a carrying unit 7 to carry substrate 2 within substrate processing part 5 at the rear of substrate transfer unit 6. At left and right sides of carrying unit 7, substrate processing units 8 to 15 to clean substrate 2 are arranged in a row in pairs in up/down and front/rear.

Also, in substrate processing apparatus 1, for example, substrates 2 from a carrier 17, on which multiple substrates 2 are placed, in substrate loading/unloading part 3 are taken one by one and carried by substrate carrying part 4 to substrate transfer unit 6. Substrate 2 is carried by carrying unit 7 from substrate transfer unit 6 to any one of substrate processing units 8 to 15, is cleaned by substrate processing units 8 to 15, is carried again by carrying unit 7 to substrate transfer unit 6, and then is unloaded by substrate carrying part 4 from substrate transfer unit 6 to carrier 17 of substrate loading/unloading part 3.

Hereinafter, the specific structure of the substrate processing units 8 to 15 to carry out cleaning processing on substrate 2 in substrate processing apparatus 1 will be described. Also, although the following description relates to the structure of substrate processing unit 8 disposed at the upper-side front area, other substrate processing units 9 to 15 is configured to have approximately the same structures.

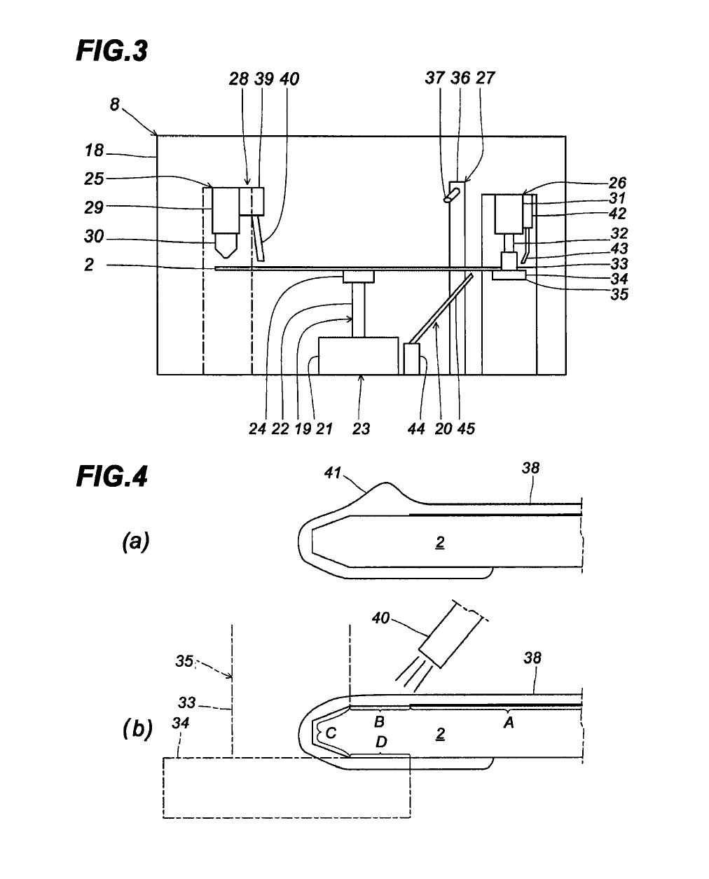

Substrate processing unit 8, as shown in FIGS. 2 and 3, includes a substrate supporter 19 to rotate substrate 2 while horizontally supporting substrate 2 within a chamber 18, a first cleaner 25 to clean the circumferential periphery of the upper surface (upper surface circumferential periphery) of substrate 2 with a pressurized cleaning liquid, a second cleaner 26 to clean the end and the circumferential periphery of the lower surface (lower surface circumferential periphery) of substrate 2 while contacting the end and the lower surface circumferential periphery of substrate 2 with a cleaning member, a upper-side cleaning liquid supplier 27 to form a liquid film interposed between substrate 2 and second cleaner 26 by supplying a cleaning liquid to the center portion of the upper surface of substrate 2, a cleaning liquid blower 28 to blow the cleaning liquid supplied from upper-side cleaning liquid supplier 27 from the upper surface circumferential periphery of substrate 2 to the outer circumference side, and a bottom-side cleaning liquid supplier 20 to supply a cleaning liquid from the lower side of substrate 2 to between substrate 2 and second cleaner 26. Also, second cleaner 26, cleaning liquid blower 28, and first cleaner 25 in substrate processing unit 8 are disposed in order along a rotation direction of substrate 2 at the circumferential periphery of substrate 2 during the cleaning.

Hereinafter, the specific configuration of substrate supporter 19, first cleaner 25, second cleaner 26, upper-side cleaning liquid supplier 27, cleaning liquid blower 28, and bottom-side cleaning liquid supplier 20, which are included in substrate processing unit 8, will be described in order.

Substrate supporter 19 includes a driving motor 21 attached to the bottom center of chamber 18, a substrate rotating mechanism 23 to rotate substrate 2 by a rotating shaft 22 of driving motor 21, and a substrate support 24 attached to the upper end of rotating shaft 22 to adsorb and support substrate 2.

In substrate supporter 19, substrate 2, which has been carried to a predetermined position by carrying unit 7, is rotated by substrate rotating mechanism 23 at a predetermined rotation rate while being horizontally supported by substrate support 24. In FIG. 2, substrate 2 is rotated in a counterclockwise direction (the left direction) from the plan view.

In first cleaner 25, a moving mechanism 29 is attached to chamber 18, and a two-fluid nozzle 30 is attached to the leading end of moving mechanism 29. Also, herein, first cleaner 25 employs two-fluid nozzle 30 which performs the cleaning by spraying a cleaning liquid including a pressurized two-fluid (for example, a cleaning liquid and nitrogen gas) as droplets toward substrate 2. However, there is no additional limitation in the configuration of first cleaner 25, as long as it has a configuration where the cleaning is carried out in a non-contact state with substrate 2 by spraying the pressurized cleaning liquid to substrate 2. For example, a jet nozzle, a spray nozzle, or a megasonic nozzle may be used.

Also, in first cleaner 25, two-fluid nozzle 30 may be horizontally moved between the position above the center of substrate 2 and the position at the outside of the circumferential periphery of substrate 2 by moving mechanism 29. Two-fluid nozzle 30 is moved back to the position at the outside of the circumferential periphery of substrate 2 during the carrying of substrate 2, and two-fluid nozzle 30 is horizontally moved from the position above the center of substrate 2 toward the position above the circumferential periphery of substrate 2 during the cleaning of the entire upper surface of substrate 2, so as to clean the circuit-pattern formed upper surface (the area designated by A in FIG. 4) and the upper surface circumferential periphery (the area designated by B in FIG. 4) of substrate 2 through spraying the two-fluid as droplets from two-fluid nozzle 30 to the upper surface of substrate 2. Also, first cleaner 25 is configured to move up/down two-fluid nozzle 30 by moving mechanism 29.

In second cleaner 26, a moving mechanism 31 is attached to chamber 18, and a rotating shaft 32 is attached to the leading end of moving mechanism 31 in the state where the leading end of rotating shaft 32 is oriented downward. Also, a sponge-type cleaning brush 35 with a reverse-T shaped cross-section, which includes a small-diameter brush 33 and a large-diameter brush 34, is attached to the leading end of rotating shaft 32. Also, herein, although second cleaner 26 employs the sponge-type cleaning brush 35, there is no additional limitation in the configuration of second cleaner 26 as long as it can perform the cleaning while being in contact with substrate 2. For example, a bristle-type cleaning brush may be used.

Also, in second cleaner 26, a support 42 is attached to the leading end of moving mechanism 31, and a supply nozzle 43 is attached to the lower end of support 42 in a direction toward cleaning brush 35.

Also, in second cleaner 26, cleaning brush 35 can be horizontally moved by moving mechanism 31 between the position above the circumferential periphery of substrate 2 and the position at the outside of the circumferential periphery of substrate 2. During the carrying of substrate 2, cleaning brush 35 is moved back to the position at the outside of the circumferential periphery of substrate 2. During the cleaning of substrate 2, cleaning brush 35 is moved to the position above the circumferential periphery of substrate 2, the outer circumference of small-diameter brush 33 is pressed against the end of substrate 2, and the upper surface of large-diameter brush 34 is pressed against the lower surface circumferential periphery of substrate 2. Herein, cleaning brush 35 is rotated by rotating shaft 32 while small-diameter brush 33 rubs and cleans the end (the area designated by C in FIG. 4) of substrate 2 and large-diameter brush 34 rubs and cleans the lower surface circumferential periphery (the area designated by D in FIG. 4) of substrate 2. Herein, second cleaner 26 supplies a cleaning liquid from supply nozzle 43 toward cleaning brush 35 to swell cleaning brush 35 with the cleaning liquid. Also, second cleaner 26 is configured to move up/down cleaning brush 35 by moving mechanism 31.

In upper-side cleaning liquid supplier 27, a support 36 is attached to chamber 18, and a supply nozzle 37 is attached to the lower end of support 36 with a slope in the direction toward the upper center portion of substrate 2.

Also, in upper-side cleaning liquid supplier 27, supply nozzle 37 discharges and supplies a cleaning liquid (for example, deionized water) toward the upper center portion of substrate 2 in an amount to form a liquid film on the upper surface of rotating substrate 2, and forms a liquid film 38 (see FIG. 4) to be interposed between substrate 2 and second cleaner 26 (specifically, cleaning brush 35) on the upper surface of substrate 2 rotated by substrate rotating mechanism 23. In this manner, the liquid film is formed on the upper surface of substrate 2 so as to prevent the cleaning liquid, including particles, from splashing and attaching on the surface (circuit-formed surface) of substrate 2.

In cleaning liquid blower 28, a support 39 is attached to moving mechanism 29 of first cleaner 25, and a blowing nozzle 40 is attached to the lower end of support 39 with a slope in the direction from the inner circumference side of substrate 2 toward the upper surface circumference.

Also, in cleaning liquid blower 28, blowing nozzle 40 sprays an inert gas (for example, nitrogen gas) in a predetermined amount from the inner circumference side of substrate 2 toward the outer circumference side, and blows the cleaning liquid supplied from upper-side cleaning liquid supplier 27 toward the outside of substrate 2 (see FIG. 4).

In bottom-side cleaning liquid supplier 20, a support 44 is attached to the bottom of chamber 18, and a supply nozzle 45 is attached to the upper end of support 44 with a slope in the direction toward the lower surface circumferential periphery of substrate 2.

Also, in bottom-side cleaning liquid supplier 20, supply nozzle 45 discharges and supplies a cleaning liquid toward the lower surface circumferential periphery of rotating substrate 2, and interposes the cleaning liquid between substrate 2 and second cleaner 26 (specifically, cleaning brush 35).

Substrate processing unit 8 is configured as described above, and cleans substrate 2 as described in the following description.

First, substrate 2 carried by carrying unit 7 is horizontally supported by substrate supporter 19 while rotating by substrate rotating mechanism 23 in a counterclockwise direction in FIG. 2 (the direction indicated by the arrow in FIG. 2) at a predetermined rotation rate. Then, upper-side cleaning liquid supplier 27 supplies the cleaning liquid in a predetermined amount toward the upper center portion of substrate 2 to form liquid film 38, and moving mechanism 29 moves first cleaner 25 from the position above the center portion of substrate 2 toward the position above the circumferential periphery of substrate 2 so as to clean the upper surface (the area designated by A in FIG. 4) of substrate 2 with the circuit pattern formed thereon by first cleaner 25.

Then, upper-side cleaning liquid supplier 27 and bottom-side cleaning liquid supplier 20 supply cleaning liquids to substrate 2, while first cleaner 25 cleans the upper surface circumferential periphery (the area designated by B in FIG. 4) of substrate 2 and second cleaner 26 cleans the end (the area designated by C in FIG. 4) of substrate 2 and the lower surface circumferential periphery (the area designated by D in FIG. 4) of substrate 2.

Next, first cleaner 25 and second cleaner 26 move back to the outside of the circumferential periphery of substrate 2, and upper-side cleaning liquid supplier 27 and bottom-side cleaning liquid supplier 20 supplies cleaning liquids to substrate 2 to carry out the rinsing processing of the substrate 2.

Then, the supply of the cleaning liquids from upper-side cleaning liquid supplier 27 and bottom-side cleaning liquid supplier 20 is stopped. Substrate 2 is rotated by substrate rotating mechanism 23 at a higher rotation rate than the rotation rate in the cleaning of the substrate, while the cleaning liquid is blown out from the surface of substrate 2 by the action of the centrifugal force, thereby drying the surface of substrate 2.

Herein, in cleaning the circumferential periphery (the upper surface circumferential periphery, the end, and the lower surface circumferential periphery) of substrate 2, if substrate 2 is rotated at a lower rate, a protrusion 41, where the cleaning liquid is upwardly risen, may be formed on the upper surface circumferential periphery of substrate 2 by the centrifugal force or surface tension acting on the cleaning liquid, or the viscosity of the cleaning liquid, as shown in FIG. 4a.

In the case where protrusion 41 of the cleaning liquid is formed on the upper surface circumferential periphery of substrate 2, when the pressurized fluid is sprayed on the upper surface circumferential periphery of substrate 2 by first cleaner 25, the cleaning liquid is scattered to the surroundings, thereby re-attaching pollutants to the upper surface of substrate 2 or polluting the inside of chamber 18. Also, due to protrusion 41 of the cleaning liquid, the pressure of the pressurized fluid sprayed from first cleaner 25 may be reduced, thereby causing the insufficient cleaning of the upper surface circumferential periphery of substrate 2.

Therefore, in substrate processing unit 8, during cleaning the circumferential periphery of substrate 2, the cleaning may be performed while cleaning liquid blower 28 sprays the inert gas from the inner circumference side of substrate 2 toward the outer circumference side as shown in FIG. 4b. Accordingly, the cleaning liquid is blown out from the upper surface circumferential periphery of substrate 2 toward the outside and protrusion 41 of the cleaning liquid is smoothed, so that the scattering of the cleaning liquid can be prevented.

Also, although bottom-side cleaning liquid supplier 20 supplies the cleaning liquid to interpose the cleaning liquid between substrate 2 and cleaning brush 35 in cleaning the lower surface circumferential periphery of substrate 2, the supply of the cleaning liquid from bottom-side cleaning liquid supplier 20 may be carried out at a position as near as possible to cleaning brush 35. Herein, the cleaning liquid supplied from bottom-side cleaning liquid supplier 20 may be scattered by colliding with cleaning brush 35.

Accordingly, in substrate processing unit 8, substrate 2 may be rotated at a low rotation rate (for example, 300 rpm) that causes the cleaning liquid supplied from upper-side cleaning liquid supplier 27 to flow around and reach the lower surface circumferential periphery of substrate 2, so that the cleaning can be carried out by supplying the cleaning liquid to substrate 2 only from upper-side cleaning liquid supplier 27 without the cleaning liquid supply from bottom-side cleaning liquid supplier 20. In other words, as shown in FIG. 4, the cleaning liquid supplied to the upper surface of substrate 2 by upper-side cleaning liquid supplier 27 may flow around and reach the lower surface circumferential periphery of substrate 2 by the action of the surface tension, and thus form liquid film 38 on the lower surface circumferential periphery of substrate 2 as well as the upper surface of substrate 2 to interpose the cleaning liquid between substrate 2 and cleaning brush 35.

In this case, in cleaning the lower surface circumferential periphery, the supply of the cleaning liquid from bottom-side cleaning liquid supplier 20 may be stopped. Also, when it is unnecessary to carry out rinsing processing on substrate 2 after the cleaning of the lower surface circumferential periphery, the configuration of substrate processing unit 8 may be simplified by removing bottom-side cleaning liquid supplier 20. Accordingly, it is possible to prevent the cleaning liquid provided from bottom-side cleaning liquid supplier 20 from scattering. Also, in cleaning the lower surface circumferential periphery, it is possible to extend the lifetime of cleaning brush 35 by rotating substrate 2 at a low rotation rate.

As described above, substrate processing apparatus 1 is configured to include a substrate cleaning device to clean the upper surface circumferential periphery, the end, and the lower surface circumferential periphery of substrate 2. Substrate processing apparatus 1 includes substrate supporter 19 to support substrate 2, first cleaner 25 to clean the upper surface circumferential periphery of substrate 2 in a non-contact state, and second cleaner 26 to clean the end and the lower surface circumferential periphery of substrate 2 in a contact state. Substrate processing apparatus 1 is configured so that the upper surface circumferential periphery of substrate 2 is cleaned in a non-contact state and the end and the lower surface circumferential periphery of substrate 2 are cleaned in a contact state.

Accordingly, in substrate processing apparatus 1 as configured above, first cleaner 25 and second cleaner 26 are used to separately control the cleaning area of the upper surface circumferential periphery of substrate 2 and the cleaning area of the lower surface circumferential periphery so that the cleaning of the circumferential periphery of substrate 2 can be optimized. The upper surface circumferential periphery of substrate 2 is cleaned by using first cleaner 25 to prevent damage to the circuit pattern or insufficient cleaning. The end and the lower surface circumferential periphery of substrate 2 are cleaned by second cleaner 26 to strongly remove pollutants attached to substrate 2 and thus inhibit the transfer of the pollutants. Thus, it is possible to satisfactorily clean the entire circumferential periphery of substrate 2.

Also, in substrate processing apparatus 1, first cleaner 25 and second cleaner 26 are simultaneously driven to simultaneously clean the upper surface circumferential periphery, the end, and the lower surface circumferential periphery of substrate 2.

Thus, in the substrate processing apparatus as configured above, the processing time required for cleaning the circumferential periphery of substrate 2 may be reduced, thereby improving the throughput of substrate processing apparatus 1.

Also, in substrate processing apparatus 1, substrate supporter 19 is provided with substrate rotating mechanism 23 to rotate substrate 2 and upper-side cleaning liquid supplier 27 to supply the cleaning liquid to the upper center portion of substrate 2. Thus, while substrate 2 is rotated, the cleaning liquid is supplied to the upper center portion of substrate 2 to carry out the cleaning.

Accordingly, in substrate processing apparatus 1 as configured above, the cleaning liquid supplied from upper-side cleaning liquid supplier 27 is uniformly spread on the upper surface of rotating substrate 2, and liquid film 38 interposed between substrate 2 and second cleaner 26 (specifically, cleaning brush 35) can be formed on the upper surface of substrate 2.

Also, in substrate processing apparatus 1, cleaning is performed in such a manner that substrate 2 is rotated by substrate rotating mechanism 23 at a rotation rate which causes the cleaning liquid supplied from upper-side cleaning liquid supplier 27 to flow around and reach the lower surface circumferential periphery of substrate 2.

Therefore, in substrate processing apparatus 1 as configured above, it is possible to prevent the cleaning liquid from scattering at the lower surface circumferential periphery of substrate 2.

Also, in substrate processing apparatus 1, cleaning liquid blower 28 to blow out the cleaning liquid supplied from upper-side cleaning liquid supplier 27 from the upper surface circumferential periphery of substrate 2 toward the outside is provided to clean substrate 2. Substrate 2 is cleaned while the cleaning liquid is blown out from the upper surface circumferential periphery of substrate 2 toward the outside.

Accordingly, in substrate processing apparatus 1 as configured above, the blowing-out of the cleaning liquid by cleaning liquid blower 28 from the upper surface circumferential periphery of substrate 2 toward the outside smoothes the cleaning liquid and thus it is possible to prevent the cleaning liquid from scattering during the cleaning by first cleaner 25.

Also, substrate processing apparatus 1 is configured to allow substrate processing units 8 to 15 to clean the entire upper surface and the circumferential periphery of substrate 2, but is not limited thereto. For example, substrate processing apparatus 1 may be configured in such a manner that first cleaner 25 is disposed at the position above the circumferential periphery of substrate 2 to clean the upper surface circumferential periphery of substrate 2 and second cleaner 26 cleans the end and the lower surface circumferential periphery of substrate 2.

Also, substrate processing apparatus 1 is configured to allow first cleaner 25 and second cleaner 26 to be simultaneously driven to simultaneously clean the upper surface circumferential periphery, the end, and the lower surface circumferential periphery of substrate 2, but is not limited thereto. For example, first cleaner 25 and second cleaner 26 may be separately driven, or the cleaning by first cleaner 25 and the cleaning by second cleaner 26 may be carried out one after another. Also, in separately driving first cleaner 25 and second cleaner 26, the upper surface circumferential periphery of substrate 2 may be cleaned by first cleaner 25 after the cleaning of the end and the lower surface circumferential periphery of substrate 2 by second cleaner 26 in consideration of the re-attachment of pollutants on the upper surface of substrate 2.

Also, in substrate processing apparatus 1, first cleaner 25 moves from the position above the center of substrate 2 toward the position above the circumferential periphery of substrate 2 to clean the circuit pattern-formed upper surface of substrate 2, and then second cleaner 26 cleans the end and the lower surface circumferential periphery of substrate 2 while first cleaner 25 cleans the upper surface circumferential periphery of substrate 2. However, substrate processing apparatus 1 may employ another configuration, in which second cleaner 26 initiates the cleaning of the end and the lower surface circumferential periphery of substrate 2 while first cleaner 25 cleans (or at the same time as first cleaner 25 starts to clean) the circuit pattern-formed upper surface of substrate 2 by moving from the position above the center portion of substrate 2 toward the position above the circumferential periphery of substrate 2. In this manner, the initiation of the cleaning on the end and the lower surface circumferential periphery of substrate 2 by second cleaner 26 during the cleaning of the circuit pattern-formed upper surface of substrate 2 by first cleaner 25 may reduce the processing time.

Also, cleaning liquid blower 28 may be disposed at the more upper stream than first cleaner 25 in the rotation direction of substrate 2. However, like substrate processing apparatus 1, cleaning liquid blower 28 disposed near to first cleaner 25 may significantly improve the effect in smoothing protrusion 41 of the cleaning liquid.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A substrate processing apparatus comprising:
a substrate supporter to support a substrate;
a first cleaner to clean an upper surface circumferential periphery of the substrate with a pressurized cleaning liquid; and
a second cleaner to clean an end and a lower surface circumferential periphery of the substrate while contacting the end and the lower surface circumferential periphery of the substrate with a cleaning member.

2. The substrate processing apparatus of claim 1, wherein a two-fluid nozzle is used as the first cleaner, and a cleaning brush is used as the second cleaner.

3. The substrate processing apparatus of claim 1, wherein the first cleaner and the second cleaner are used to simultaneously clean the upper surface circumferential periphery, the end, and the lower surface circumferential periphery of the substrate.

4. The substrate processing apparatus of claim 1, wherein a substrate rotating mechanism to rotate the substrate is provided in the substrate supporter, and an upper-side cleaning liquid supplier is provided to supply a cleaning liquid to an upper center portion of the substrate.

5. The substrate processing apparatus of claim 4, wherein the substrate rotating mechanism rotates the substrate at a rotation rate that causes the cleaning liquid supplied from the upper-side cleaning liquid supplier to flow around the end of the substrate and reach the lower surface circumferential periphery of the substrate.

6. The substrate processing apparatus of claim 4, wherein a cleaning liquid blower is provided to blow out the cleaning liquid supplied from the upper-side cleaning liquid supplier from the upper surface circumferential periphery of the substrate toward outside of the substrate.

7. The substrate processing apparatus of claim 1, wherein the first cleaner is provided with a moving mechanism, and the first cleaner moves from a position above the upper center portion of the substrate to a position above the upper surface circumferential periphery to clean the upper surface of the substrate.

8. The substrate processing apparatus of claim 1, wherein a bottom-side cleaning liquid supplier is provided to supply a cleaning liquid to the lower surface circumferential periphery of the substrate.

9. A substrate cleaning method comprising:
cleaning an upper surface circumferential periphery of a substrate with a pressurized cleaning liquid; and
cleaning an end and a lower surface circumferential periphery of the substrate while contacting the end and the lower surface circumferential periphery of the substrate with a cleaning member.

10. The substrate processing method of claim 9, wherein the upper surface circumferential periphery of the substrate, and the end and the lower surface circumferential periphery of the substrate are cleaned simultaneously.

11. The substrate processing method of claim 9, wherein the method further comprises rotating the substrate and supplying the cleaning liquid to an upper center portion of the substrate.

12. The substrate processing method of claim 11, wherein the substrate is rotated at such a rotation rate that the cleaning liquid flows around the end of the substrate and reaches the lower surface circumferential periphery of the substrate.

13. The substrate processing method of claim 11, wherein the method further comprises blowing out the cleaning liquid from the upper surface circumferential periphery of the substrate toward outside of the substrate.

14. The substrate processing method of claim 9, wherein the method further comprises cleaning from the upper center portion to the upper surface circumferential periphery of the substrate.

15. The substrate processing method of claim 9, wherein the method further comprises rinsing the substrate by supplying a cleaning liquid to the upper surface circumferential periphery, the end, and the lower surface circumferential periphery of the substrate after the upper surface circumferential periphery, the end, and the lower surface circumferential periphery of the substrate are cleaned.
